(19) United States
(12) Patent Application Publication
(10) Pub. No.: US 2025/0053585 A1
(43) Pub. Date: Feb. 13, 2025

(54) KEYWORD SELECTION FOR SKILLS INFERENCE

(71) Applicant: INTERNATIONAL BUSINESS MACHINES CORPORATION, ARMONK, NY (US)

(72) Inventors: Irving A. Duran, Dubuque, IA (US); Antonella Vaccina, Bari (IT)

(21) Appl. No.: 18/232,498

(22) Filed: Aug. 10, 2023

(51) Int. Cl. G06F 16/33; G06Q 10/0631

(52) U.S. Cl. CPC G06F 16/334; G06Q 10/063112

(57) ABSTRACT

A method, computer program product, and computer system for determining keywords from raw data. A first trained artificial intelligence (AI) model is used to extract, from text associated with first and second persons, a first and second plurality of keywords for each first and second person, respectively. A second AI model is used to determine, for each keyword, a similarity score which is zero for each keyword consisting of a single word and is a numerical measure of similarity between the two words in each keyword consisting of two words. A composite score is computed as a function of a keyword frequency rank, a similarity rank, and a person frequency rank for each keyword. A final list of keywords is generated and consists of keywords in the second plurality of keywords based on the composite score of all of the keywords in both the first and second plurality of keywords.

### BACKGROUND

The present invention relates to assessment of skills and inference of skill expertise of employees in an organization, and more specifically, to improving accuracy of skills expertise level inference for employees having either non-technical skills and or technical skills that lack differentiating keywords in an Expertise Taxonomy.

### SUMMARY

Embodiments of the present invention provide a method, a computer program product, and a computer system, for determining keywords from raw data.

One or more processors of a computer system receive a first list of first persons and a second list of second persons. The second persons have been classified as having a higher skill level than the first persons with respect to specified skill level criteria of a specified skill.

The one or more processors use a first trained artificial intelligence model to extract, from text associated with the first persons and the second persons, a first plurality of keywords and a second plurality of keywords for each first person and each second person, respectively. Each extracted keyword independently consists of either a single word or two words.

The one or more processors use a second trained artificial intelligence model to determine a similarity score for each keyword of the first plurality of keywords and for each keyword of the second plurality of keywords. The similarity score is zero for each keyword consisting of a single word and is a numerical measure of similarity between the two words in each keyword consisting of two words.

The one or more processors determine a keyword frequency rank, a mean similarity rank, and a person frequency rank for each keyword of the first plurality of keywords and for each keyword of the second plurality of keywords.

The one or more processors compute a composite score as a function of the keyword frequency rank, the similarity rank, and the person frequency rank for each keyword of the first plurality of keywords and for each keyword of the second plurality of keywords.

The one or more processors generate a final list of keywords consisting of keywords in the second plurality of keywords based on the composite score of all of the keywords in both the first plurality of keywords and the second plurality of keywords.

### BRIEF DESCRIPTION OF THE DRAWINGS

FIG. 1 is a flow chart of an embodiment of a method for ascertaining final keywords derived from raw text of non-experts and experts, in accordance with embodiments of the present invention.

FIG. 2 is a flow chart of an embodiment of a method for ascertaining final keywords derived from raw text of first persons and second persons, in accordance with embodiments of the present invention.

FIG. 3 is a flow chart of an embodiment of a method for ascertaining a skill level of an individual person, in accordance with embodiments of the present invention.

FIG. 4 is a flow chart describing use of a first Artificial Intelligence (AI) model, using Natural Language Processing (NLP) techniques, to extract keywords of one or more persons from raw text of the persons, in accordance with embodiments of the present invention.

FIG. 5 is a flow chart which describes training the first AI model, in accordance with embodiments of the present invention.

FIG. 6 is a flow chart describing use of a second Artificial Intelligence (AI) model to determine a similarity of extracted keywords, in accordance with embodiments of the present invention.

FIG. 7 is a flow which describes training the second AI model, in accordance with embodiments of the present invention.

FIG. 8 illustrates a computer system, in accordance with embodiments of the present invention.

FIG. 9 depicts a computing environment which contains an example of an environment for the execution of at least some of the computer code involved in performing the inventive methods, in accordance with embodiments of the present invention.

### DETAILED DESCRIPTION

Assessment of skills and of skill expertise of employees in an organization is a strategic and business objective. Both self-assessment and assessment by managers are not reliable because self-assessment and assessment by managers lack consistency across different teams and organization departments and are not updated frequently. Automated skills assessment based on Expertise Taxonomy specified by the organization, and an overall employee digital footprint is used to accelerate and standardize assessment in large organizations. An Expertise Taxonomy is defined as a classification of expertise levels or skill levels of a skill or job. A digital footprint of an individual is defined as data pertaining to the individual resulting from interactions of the individual in a digital environment such as, inter alia, the World Wide Web, the Internet, television, mobile phone, and any other connected device.

Skills inference goes a step beyond skills assessment by focusing on the skills expertise level rather than skills identification. Supervised skills inference methods can be used by on-line professional services that have collected large quantities of social recognition, job-related, and self-assessment data. However, social recognition data is often unreliable and in absence of sufficient and/or reliable data, organizations use unsupervised or semi-supervised methods that rely on keyword-based searches to distinguish among expertise levels for all employees and all skills in the organization's Expertise Taxonomy. Accuracy of results, which may be expressed as percentage agreement between inferred levels and user feedback, is strongly dependent on quality of keywords. Skill descriptions in the Expertise Taxonomy are the main and trusted source of keywords for skills inference. Various unsupervised or semi-supervised machine learning models can then be applied to infer the skills expertise levels.

Descriptions for technical skills are generally clear and reliable to identify unique, non-general keywords for inference applying standard Natural Language Processing (NLP) techniques. Descriptions for non-technical or similar skills frequently have a non-sufficient quality to allow good keywords identification. Thus, the average percentage of agreement for non-technical skills is lower than the percentage of agreement for technical skills.

Embodiments of the present invention provide a method for improving accuracy of skills expertise level inference for non-technical skills and technical skills that lack differentiating keywords in the Expertise Taxonomy.

Embodiments of the present invention generate new keywords and rank the new keywords using a capability of the new keywords to differentiate among expertise levels for given skills.

Embodiments of the present invention use Part-of-Speech (PoS) tagging and dependency parsing coupled with scores for ranking keywords between Experts and Non-Expert groups. In one embodiment, experts have technical skills and non-experts have non-technical skills.

Embodiments of the present invention provide a method to discover new keywords to describe skills that have a poor description in the Expertise Taxonomy, by analyzing unstructured data (i.e., raw data) in the digital footprint of employees. In one embodiment, an additional input is employee skill level (identified by self-assessment, manager assessment, or by skills inference itself).

Embodiments of the present invention use NLP tool features (e.g., PoS tagging and dependency parsing) to extract keywords and associated semantic features (e.g., verbs, nouns, direct objects, and adjectives) from the text in digital footprint of the selected employees. Keyword ranking methodology of the present invention, in combination with selection of keywords based on threshold and exclusion of keywords where experts and non-experts have the same keywords, facilitates narrowing down keywords to a good set of curated keywords.

Embodiments of the present invention provide a process that generates the following three keyword relative rankings, in ascending or descending order, of: (i) keyword frequency; (ii) similarity between: each keyword verb with direct object, each keyword verb with noun, and each keyword verb with adjective; and (iii) distinct number of people using that keyword. When the keyword relative rankings for the group have been created, then a composite score is created by combining the three relative ranking results (e.g., by computing an arithmetic average of the three relative ranking results). The composite score may be used to select keywords that meet a specified threshold composite score.

The preceding process is repeated for two groups of employees: experts and non-experts.

The final list of curated keywords is determined using expert keywords that have a composite score equal to or greater than a specified composite score threshold and/or are not used by non-expert employees.

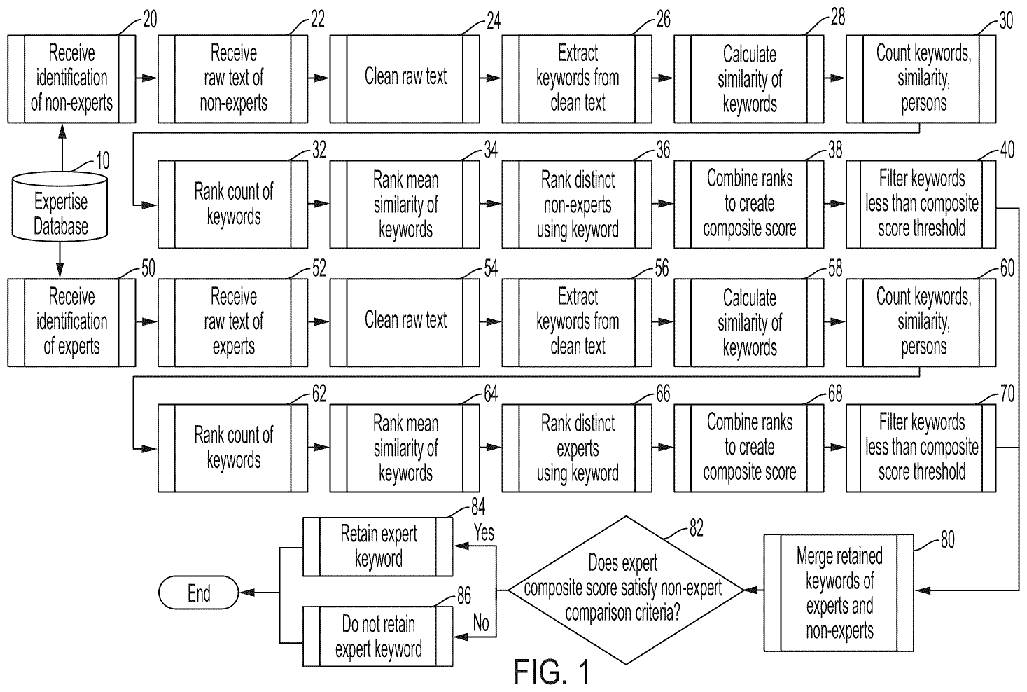

FIG. 1 is a flow chart of an embodiment of a method for ascertaining final keywords derived from raw text of non-experts and experts, in accordance with embodiments of the present invention. The method of FIG. 1 includes steps 20-86. Steps 20-40 pertain to keywords of non-experts, steps 50-70 pertain to keywords of experts, and steps 80-86 pertain to merging keywords of experts and non-experts.

Tables 1-4 infra provide a concrete example of the method depicted in FIG. 1.

FIG. 1 depicts an expertise database 10 that includes identification persons who are experts and persons who are non-experts.

“Expert” and “non-expert” are relative terms defined as follows. An expert is a personal having a higher skill level than a non-expert with respect to a specified skill level criteria for a skill. For example, for a skill of engineering, skill level criteria could include, inter alia, a highest relevant education degree in engineering or science (e.g., B.S., M.S., PhD), years of engineering or scientific experience, etc., or combinations thereof.

In one embodiment, the preceding identification of non-experts and experts is input to the method of FIG. 1, wherein a direct determination of who is an expert and who is a non-expert is not performed by the method of FIG. 1.

The method of FIG. 1 is not limited to non-experts and experts and is generally applicable to any group of first persons and second persons, respectively, by substituting first persons and second persons for non-experts and experts, respectively, in the description of FIG. 1.

Steps 20 and 50 receive identification of non-experts and experts, respectively. The identification of the non-experts and experts may be received from any source such as, inter alia, expertise database 10, user input, etc.

Steps 22 and 52 receive raw text of the non-experts identified in step 20 and the experts identified in step 50, respectively. Raw text is defined as original text prior to being cleaned as in steps 24 and 54 described infra.

The raw text of the non-experts and experts may be received from any source such as, inter alia, telephone conversations, newswire, newsgroups, broadcast news, broadcast conversations, weblogs, user input, etc.

Steps 24 and 54 clean the raw text received in steps 22 and 52, respectively, to convert the raw text into a more usable and structured format for subsequent analysis. Cleaning the structured text may be selected from such standard techniques as, inter alia, removing stop words (i.e., common words such as, inter alia, a”, “an”, “and”, “but”, “in”, “on”, “the”, “what”, “will”, which are removed, in one embodiment, by comparison of the raw text with a specified list of stop words), removing or correcting errors, filling in missing values, transforming data types reshaping the data to fit a desired format, case normalization (converting all the words to lowercase or uppercase), punctuation normalization (removing or replacing punctuation marks to improve the readability of the text), lemmatization (reducing words to their base form or lemma to capture the underlying meaning of the word). The preceding standard techniques are well known to a person of ordinary skill in the art.

TABLE 1
Exemplary items of raw text and associated clean text

| Raw Text | Clean Text |
|---|---|
| The skills required to execute work are many | skills require execute work many |
| in the machine, there are 3 main components. | machine main component |
| Knowledge and skill are two different capabilities | knowledge skill different capability |
| Fast growth, with productivity yields progress | fast growth productivity yield progress |
| Individuals designed the building across the street | individual design building across street |
| ability to direct employees to their work location | ability direct employee work location |
| develop strategy for the project “PLAN IT” | develop strategy project plan |
| Planning growth strategy; e.g., expand resources | plan growth strategy expand resource |
| Identify preference for bulk purchases | identify preference bulk purchase |

Table 1 illustrates the result of performing steps 22, 24 and 52, 54 by showing a concrete example of raw text and associated clean text of one or more non-experts and/or experts, respectively. Table 1 serves to illustrate raw text and associated clean text regardless of whether the raw text is from a non-expert or from an expert.

Steps 26 and 56 extract keywords from the clean text generated in steps 24 and 54 associated with the non-experts and experts, respectively. Each extracted keyword independently consists of either a single word or two words, as illustrated in Tables 2 and 3.

In one embodiment, each extracted keyword is tagged (i.e., marked up) with a tag that denotes: (i) a part-of-speech (PoS) (e.g., verb, direct object, adjective, adverb, etc.) for a single-word keyword or (ii) a PoS combination (e.g., verb-direct object, verb-noun, verb-adjective, adjective-noun, etc.) for a two-word keyword.

The two-word keywords are two words in the clean text that that have a syntactical relationship with each other in the raw text, as determined by dependency parsing, where the dependency parsing is used in a manner known to a person of ordinary skill in the art. Thus, all pairs of two words, in the clean text, in which there is no determined syntactical relationship between the two words of the pair are not determined to be a two-word keyword. Accordingly, the dependency parsing serves as a filter that screens out all two-word pairs lacking a syntactical relationship between the two words in the pair.

In one embodiment, a first artificial intelligence (AI) model is used to perform steps 24 and 26, as well as steps 54 and 56. Thus in this embodiment, the input to the first AI model includes the raw text of the non-experts and the experts respectively provided by the output of steps 22 and 52, and the output from execution of the first AI model includes the non-expert keywords and the expert keywords respectively resulting from execution of steps 26 and 56, respectively.

In one embodiment, the first AI model is used to perform steps 26 and 56, and steps 24 and 54 are performed outside of, and prior to, performance of the first AI model. Thus in this embodiment, the input to the first AI model includes the clean text of the non-experts and the experts respectively resulting from execution of steps 24 and 54, and the output from execution of the first AI model includes the non-expert keywords and the expert keywords respectively resulting from execution of steps 26 and 56.

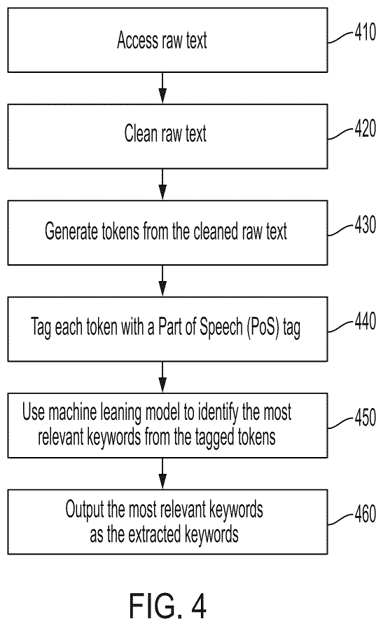

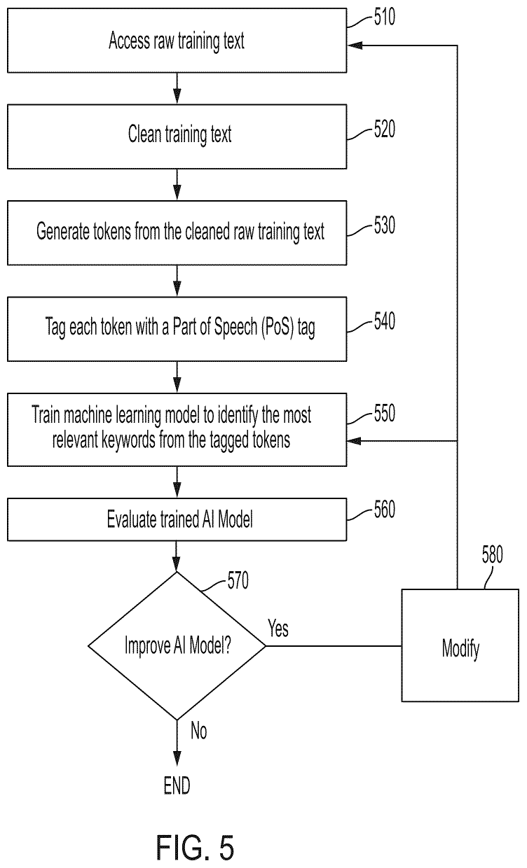

A flow chart describing use of the trained first AI model for performing steps 24, 26, 54 and 56 is presented infra in conjunction with FIG. 4, and a flow chart for training the first AI model is presented infra in conjunction with FIG. 5.

Steps 28 and 58 use a second artificial intelligence (AI) model to determine a similarity score for each keyword extracted in steps 26 and 56 for the non-experts and the experts, respectively.

The similarity score is zero for each keyword consisting of a single word and is a numerical measure of similarity between the two words in each keyword consisting of two words.

In case of multiple appearance, in the raw text, of each word of a two-word keyword, there may be multiple values of the similarity score of the two-word keyword, because the similarity score depends on the syntactical relationship between the two words of the pair and there may be multiple such syntactical relationships in the raw text for the words of the two-word keyword. Thus, for a two-word keyword having multiple similarity scores, a mean similarity is computed as the mean (i.e., arithmetic average) of the multiple similarity scores of the two-word keyword. For a two-word keyword having exactly one similarity score, the mean similarity is the one similarity score. For a single-word keyword, the mean similarity is zero.

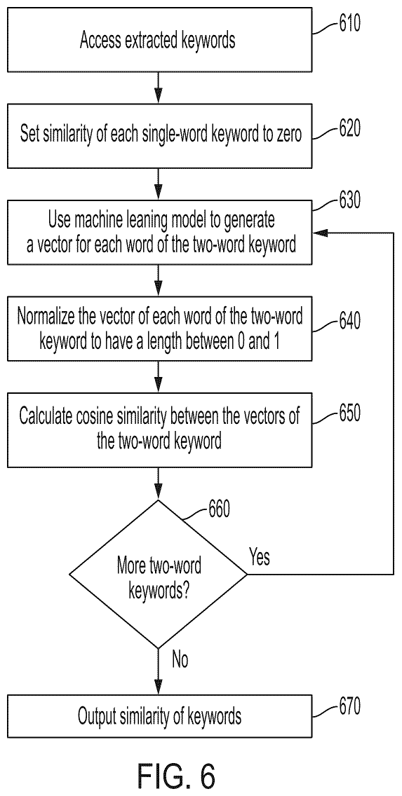

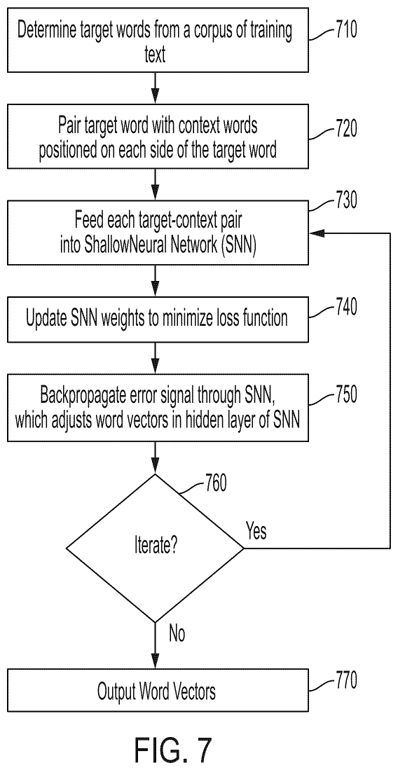

A flow chart describing use of the trained second AI model for performing steps 28 and 58 is presented infra in conjunction with FIG. 6, and a flow chart for training the second AI model is presented infra in conjunction with FIG. 7.

Steps 30 and 60 determine a keyword frequency count, a mean similarity, and a person frequency count for each keyword extracted in steps 26 and 56 for the non-experts and experts, respectively.

The keyword frequency count for each unique keyword is a total number of times each extracted unique keyword appears in the keywords extracted in steps 26 and 56 for the non-experts and experts, respectively.

The mean similarity for each unique keyword is determined as an arithmetic average of the keyword similarity scores calculated in steps 28 and 58 for each keyword of the keywords extracted in steps 26 and 56 for the non-experts and experts, respectively.

The person frequency count for each unique keyword is a total number of times each non-expert and each expert appears in the keywords extracted in steps 26 and 56 for the non-experts and experts, respectively.

Steps 32, 34, and 36 respectively determine, for each unique keyword, the parameters of: a first rank of the keyword frequency count, a second rank of the mean similarity, and a third rank of the person frequency count determined in step 30 for the non-experts.

Steps 62, 64, and 66 respectively determine, for each unique keyword, the parameters of: a first rank of keyword frequency count, a second rank of the mean similarity, and a third rank of the person frequency count determined in step 60 for the experts.

In one embodiment, each rank of the first rank, the second rank and the third rank is a percentile rank (PR) of the parameter in the frequency distribution, although any rank definition known to a person of ordinary skill in the art may be used.

The following discussion expresses PR as a decimal in range of 0 to 1.

A first embodiment for the parameter is PR=(CF−F/2)/N, and a second embodiment for the parameter is PR=(CF′+F/2)/N, wherein N is the total number scores of the parameter in the distribution, F is the frequency of the score of interest for the parameter, CF is the count of all scores less than or equal to the score of interest (F). CF′ is the count of all scores less than the score of interest (F).

After PR is calculated for the first or second embodiment, PR is normalized to constrain PR be in a range of 0 to 1.

Steps 38 and 68 compute a composite score by combining the first, second and third ranks for each keyword extracted in steps 26 and 56 for the non-experts and experts, respectively. In one embodiment, the composite scores are normalized to be in a range of 0 to 1 after combining the first, second and third ranks.

In one embodiment, the composite score is an unweighted or weighted arithmetic average of the first, second and third ranks.

In one embodiment, the composite score is an unweighted or weighted root mean square (RMS) of the first, second and third ranks.

Steps 40 and 70 filter (i.e., remove) keywords whose composite score is less than the specified composite score threshold for the non-experts and experts, respectively. Thus, the retained keywords (i.e., the keywords not removed) each have a composite score that is equal to or greater than the specified composite score threshold.

TABLE 2
Non-expert Keyword Statistics

| | | | Person | Keyword | Mean | Person | |
|---|---|---|---|---|---|---|---|
| | Keyword | Mean | Freq | Freq | Similarity | Freq | Composite |
| Keyword | Frequency | Similarity | Count | Rank | Rank | Rank | Score |
| Initiative | 8 | 0.00000 | 1 | 1.00000 | 0.41558 | 0.50000 | 0.63853 |
| process | 3 | 0.00000 | 2 | 0.60000 | 0.41558 | 1.00000 | 0.67186 |

TABLE 3
Expert Keyword Statistics

| | | | Person | Keyword | Mean | Person | |
|---|---|---|---|---|---|---|---|
| | Keyword | Mean | Freq | Freq | Similarity | Freq | Composite |
| Keyword | Frequency | Similarity | Count | Rank | Rank | Rank | Score |
| affect | 2 | 0.20075 | 2 | 0.66667 | 1.00000 | 0.66667 | 0.77778 |
| transition | | | | | | | |
| initiative | 17 | 0.00000 | 3 | 1.00000 | 0.48333 | 1.00000 | 0.82778 |
| leadership | 2 | 0.00000 | 2 | 0.66667 | 0.48333 | 0.66667 | 0.60556 |
| privacy | 2 | .000000 | 2 | 0.66667 | 0.48333 | 0.66667 | 0.60556 |

Tables 2 and 3 illustratively depict, for each retained keyword, the keyword frequency count, the mean similarity, the person frequency count, the keyword frequency rank, the mean similarity rank, the person frequency rank, and the composite score after keywords have been filtered in steps 40 and 70 for non-experts and experts, respectively, based on a composite score threshold of 0.60. The composite scores depicted in Tables 2 and 3 were computed as an arithmetic average of the keyword frequency rank, the mean similarity rank, and the person frequency rank.

It is noted that the data in Tables 2 and 3 are not evident from the data depicted in Table 1, because Table 1 is incomplete due to depicting, by Table 1, only a small percent of the raw text and the associated cleaned text, for non-experts and experts.

Step 80 merges the expert composite scores with the non-expert composite scores, based on the associated retained keywords with a composite score threshold of 0.60 in this example, to generate a list of final keywords (illustrated in Table 4 infra) derived from the retained keywords of the experts as implemented in steps 82, 84 and 86.

For each retained keyword of the experts, step 82 makes the following determination. If step 82 determines that the retained keyword of the expert is not a retained keyword of any of the non-experts or that the composite score of the retained keyword of the expert exceeds the composite score of the same retained keyword of the non-experts, then the retained keyword of the expert becomes a keyword in the list of final keywords (step 84); otherwise, the retained keyword of the expert does not become a keyword in the list of final keywords (step 86)

TABLE 4
Final Keywords

| Keyword | Composite Score |
|---|---|
| initiative | 0.82778 |
| affect transition | 0.77778 |
| leadership | 0.60556 |
| privacy | 0.60556 |

Table 4 is a list of final keywords derived by applying steps 82, 84 and 86 to Tables 2 and 3.

The composite score (0.82778) of the retained keyword of “initiative” in Table 3 (experts) exceeds the composite score (0.63853) of the same retained keyword of “initiative” in Table 2 (non-experts) and thus appears as a final keyword in Table 4.

The retained keywords of “affect transition”, “leadership” and “privacy” in Table 3 (experts) do not appear as retained keywords in Table 2 (non-experts) and thus appear as final keywords in Table 4.

The list of final keywords in Table 4 includes the composite score associated with each final keyword.

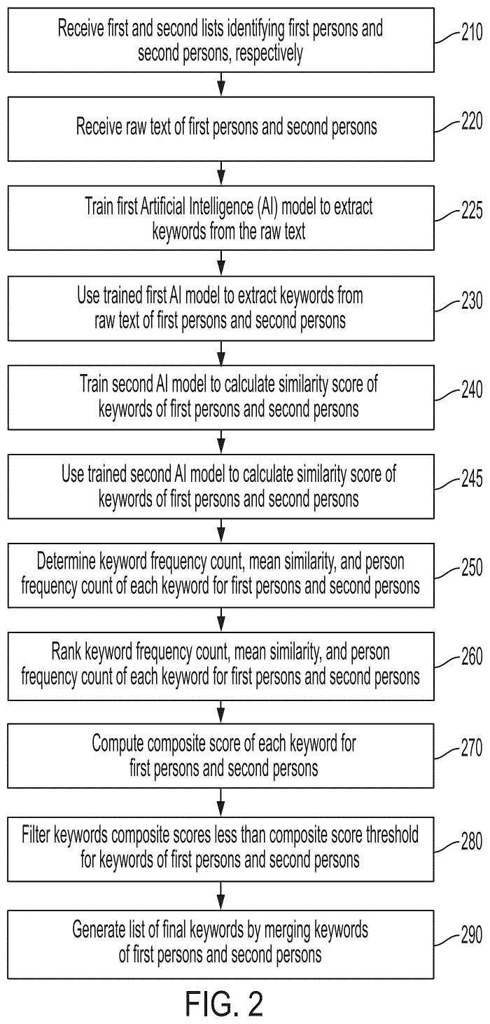

FIG. 2 is a flow chart of an embodiment of a method for ascertaining final keywords derived from raw text of first persons and second persons, in accordance with embodiments of the present invention. The flow chart of FIG. 2 includes steps 210-290.

Step 210 receives a first list of first persons and a second list of second persons. Step 210 corresponds to steps 20 and 50 of FIG. 1.

The identification of the first persons and the second persons may be received from any source such as, inter alia, the expertise database 10 in FIG. 1, user input, etc.

The second persons have been classified as having a higher skill level than the first persons with respect to specified skill level criteria of a specified skill.

The word “skill” encompasses any capability or credential, including, expertise, education, experience, job, etc.

The first persons and the second persons are related as illustrated, inter alia, in the following non-exhaustive embodiments.

In one embodiment, the first persons and the second persons correspond to non-experts and experts, respectively, in FIG. 1. In one embodiment, the first persons and the second persons respectively correspond to less experienced persons and more experienced persons. In one embodiment, the first persons and the second persons respectively correspond to persons holding a job paying a lower salary lower than a specified threshold salary and persons holding a job paying a salary of at least the specified threshold salary.

Illustratively in one embodiment, for a skill of engineering, skill level criteria could include, inter alia, a highest relevant education degree in engineering or science (e.g., B.S., M.S., PhD), years of engineering or scientific experience, etc., or combinations thereof.

The identification of first persons and second persons is input to the method of FIG. 2, wherein a direct determination of who is a first person and who is a second person is not performed by the method of FIG. 2.

Step 220 receives raw text of the first persons and the second persons. Raw text is defined as original text prior to being cleaned as described infra in step 230. Step 220 corresponds to steps 22 and 52 in FIG. 1.

The raw text of the first persons and the second persons may be received from any source such as, inter alia, telephone conversations, newswire, newsgroups, broadcast news, broadcast conversations, weblogs, user input, etc.

Step 225 trains a first AI model to extract keywords from any raw text of one or more persons. Each extracted keyword independently consists of either a single word or two words.

In one embodiment, step 225 is not performed if the trained first AI model already exists.

Step 230 uses the trained first AI model to extract, from the raw text, a first plurality of keywords for each first person and a second plurality of keywords for each second person. Each extracted keyword independently consists of either a single word or two words. Step 23 corresponds to steps 24, 26, 54 and 56 and 52 in FIG. 1.

In one embodiment, each extracted keyword is tagged (i.e., marked up) with a tag that denotes: (i) a part-of-speech (PoS) (e.g., verb, direct object, adjective, adverb, etc.) for a single-word keyword or (ii) a PoS combination (e.g., verb-direct object, verb-noun, verb-adjective, adjective-noun, etc.) for a the two-word keyword.

The two-word keywords are two words in the clean text that that have a syntactical relationship with each other in the clean text, as determined by dependency parsing, where the dependency parsing is used in a manner known to a person of ordinary skill in the art. Thus, all pairs of two words, in the clean text, in which there is no determined syntactical relationship between the two words of the pair are not determined to be a two-word keyword. Accordingly, the dependency parsing of the clean text serves as a filter that screens out all two-word pairs, in the clean text, lacking a syntactical relationship between the two words in the pair.

A flow chart that describes using the trained first AI model to extract keywords from the raw text of the first persons and the second persons (step 230) is presented infra in conjunction with FIG. 4, and a flow chart that describes training the first AI model (step 225) is presented infra in conjunction with FIG. 5.

Step 240 trains a second AI model to calculate a similarity score of the keywords of the first persons and the second persons. In one embodiment, step 240 is not performed if the trained second AI model already exists.

Step 245 calculates the similarity score of the keywords of the first persons and the second persons. Step 245 corresponds to steps 28 and 58 in FIG. 1.

The similarity score is zero for each keyword consisting of a single word and is a numerical measure of similarity between the two words in each keyword consisting of two words.

A flow chart describing use of the trained second AI model for performing step 245 is presented infra in conjunction with FIG. 6, and a flow chart that describes training the second AI model (step 240) is presented infra in conjunction with FIG. 7.

Step 250 determines a keyword frequency count, a mean similarity, and a person frequency count of each keyword for the first persons and the second persons. Step 245 corresponds to steps 30 and 60 in FIG. 1.

The keyword frequency count for each unique keyword is a total number of times each extracted unique keyword appears in the keywords extracted in step 235 for the first persons and the second persons.

The mean similarity for each unique keyword is determined as an arithmetic average of the keyword similarity scores calculated in step 245 for each keyword of the keywords extracted in step 230 for the first persons and the second persons.

The person frequency count for each unique keyword is a total number of times each first person and each second person appears in the keywords extracted in step 230 for the first persons and the second persons.

Step 260 determines, for each unique keyword of the first persons and the second persons, the parameters of: a rank of the keyword frequency count, a rank of the mean similarity, and a rank of the person frequency count determined in step 250. Step 260 corresponds to steps 32, 34, 36, 62, 64 and 66 in FIG. 1.

In one embodiment, each rank of the first rank, the second rank and the third rank is a percentile rank (PR) of the parameter in the distribution, although any rank definition known to a person of ordinary skill in the art may be used.

The following discussion expresses PR as a decimal in range of 0 to 1.

A first embodiment of PR for the parameter is PR=(CF−F/2)/N, and a second embodiment of PR for the parameter is PR=(CF′+F/2)/N, wherein N is the total number scores of the parameter in the distribution, F is the frequency of the score of interest for the parameter, CF is the count of all scores less than or equal to the score of interest (F). CF′ is the count of all scores less than the score of interest (F).

After PR is calculated for the first or second embodiment, PR is normalized to constrain PR be in a range of 0 to 1.

Step 270 computes a composite score for the first persons and the second persons, by combining the first, second and third rankings for each keyword extracted in step 225 for the first persons and the second persons. Step 270 corresponds to steps 38 and 68 in FIG. 1.

In one embodiment, the composite score is an unweighted or weighted arithmetic average of the first, second and third ranks.

In one embodiment, the composite score is an unweighted or weighted root mean square (RMS) of the first, second and third ranks.

For each password, KFR denotes the keyword frequency rank, SR denotes the similarity rank, PFR denotes the person frequency rank, and CS denotes the composite score.

In a first embodiment, the composite score (CS) is computed as CS=(w1*(KFR)ⁿ¹+w2*(SR)ⁿ²+w3*(PFR)ⁿ³)/3 wherein w1, w2, w3, n1, n2, and n3 are positive real numbers. The coefficients w1, w2 and w3 are relative, normalized or un-normalized, weights of (KFR)ⁿ¹, (SR)ⁿ², and (PFR)ⁿ³, respectively.

In one embodiment, the weights (w1, w2 w3) can each be received as input.

In one embodiment, the weights (w1, w2 w3) can each be dependent on the Part of Speech (PoS), or PoS combination, of the associated keyword, as illustrated infra in Table 5.

TABLE 5
Exemplary Relative Weights

| POS | w1 | w2 | w3 |
|---|---|---|---|
| verb | .50 | .90 | 1 |
| noun | .40 | .80 | 1 |
| adjective | .30 | .70 | 1 |
| direct object | .20 | .60 | 1 |
| verb-noun | .75 | .50 | 1 |
| verb-adjective | .65 | .40 | 1 |
| verb-direct object | .55 | .30 | 1 |

The relative weights in Table 5 are for illustrative purposes only. In general, the relative weights (w1, w2, w3) can have any numerical values and there can be other PoS items, and other combinations of items, than the PoS items and combinations shown in Table 5.

In one example, w1=w2=w3=1 and n1=n2=n3=1, so that CS=(KFR+SR+PFR)/3.

In one example, at least one of n1, n2, and n3 exceeds 1; e.g., n1=2, n2=1, n3=3; n1=2, n2=3, n3=2; n=1, n2=2, n3=0.5.

In second embodiment, CS=[((KFR)ⁿ+(SR)ⁿ+(PFR)ⁿ)/3]^{1/n}, wherein n is a positive real number; e.g., n=0.5, 1, 1.5, 2, 3, 4, etc., so that CS is a root mean square (RMS) of KFR, SR and PFR for the case of n=2.

In a third embodiment, CS=KFR*SR*PFR if SR>0 and CS=KFR*PFR if SR=0.

Step 280 filters (i.e., removes) keywords whose composite score is less than a specified composite score threshold for the first persons and the second persons. The specified composite score threshold is a positive real number. Thus, the retained keywords (i.e., the keywords not removed) each have a composite score that is equal to or greater than the specified composite score threshold. Step 280 corresponds to steps 40 and 70 in FIG. 1.

Thus, step 280 generates a third plurality of keywords and a fourth plurality of keywords comprising only those keywords in the first plurality of keywords and in the second plurality of keywords, respectively, whose composite score is equal to or greater than the specified composite score threshold.

Step 290 generates a list of final keywords by merging the keywords of the first persons and the keywords of the second persons after performance of the filtering step 280. Step 290 corresponds to steps 80, 82, 84 and 86 in FIG. 1.

For each retained keyword of the second persons, step 290 makes the following determination. If step 290 determines that the retained keyword of the second person is not a retained keyword of any first person or that the composite score of the retained keyword of the second exceeds the composite score of the same retained keyword of a first person, then the retained keyword of the second person becomes a keyword in the list of final keywords; otherwise, the retained keyword of the second person does not become a keyword in the list of final keywords.

Thus, the final list of keywords consists of (i) all keywords in the fourth plurality of keywords not existing in the third plurality of keywords and (ii) all keywords in the fourth plurality of keywords whose composite score exceeds the composite score of the same keywords in the third plurality of keywords.

The list of final keywords includes each final keyword and the composite score of each final keyword.

Steps 280 and 290, in combination, may be alternatively described as follows.

A final list of keywords is generated, wherein the final list of keywords consists of keywords in the second plurality of keywords based on the composite score of all of the keywords in both the first plurality of keywords and the second plurality of keywords.

Thus, generating the final list of keywords comprises: (i) generating a third and fourth plurality of keywords comprising only those keywords in the first and second plurality of keywords, respectively, whose composite score is equal to or greater than a specified composite score threshold that is a positive real number; and (ii) creating the final list of keywords consisting of keywords in the fourth plurality of keywords based on a comparison of the keywords in the fourth plurality of keywords with keywords in the third plurality of keywords.

The final list of keywords resulting from the preceding comparison consists of (i) all keywords in the fourth plurality of keywords not existing in the third plurality of keywords and (ii) all keywords in the fourth plurality of keywords whose composite score exceeds the composite score of the same keywords in the third plurality of keywords.

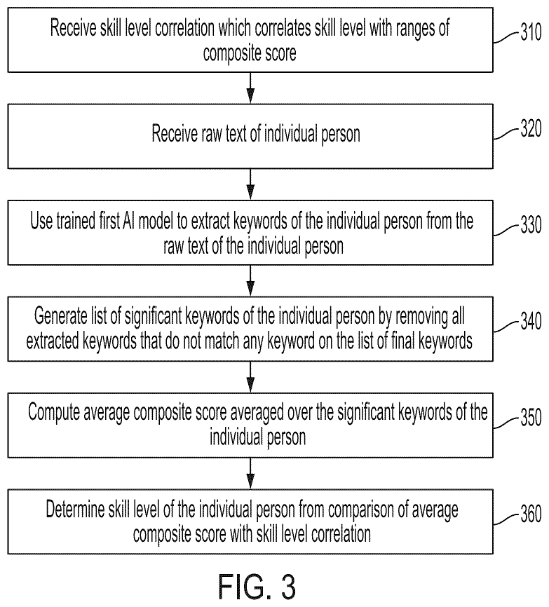

FIG. 3 is a flow chart of an embodiment of a method for ascertaining a skill level of an individual person, in accordance with embodiments of the present invention. The flow chart of FIG. 3 includes steps 310-360.

Step 310 receives a skill level correlation which correlates skill level with ranges of composite score.

Step 320 receives raw text of the individual person.

Step 330 uses the trained first AI model to extract keywords of the individual person from the raw text of the individual person, using the methodology described supra in conjunction with steps 24, 26, 54 and 56 of FIG. 1 or with step 225 of FIG. 2.

Step 340 generates a list of significant keywords of the individual person by removing all extracted keywords of the individual person (from result of step 330) that do not match any keyword on the list of final keywords generated in steps 80, 82, 84, 86 in FIG. 1 or in step 290 in FIG. 2.

The list of significant keywords of the individual person includes the significant keywords and the composite score of each significant keyword obtained from the list of final keywords.

Step 350 computes an average composite score averaged over the significant keywords of the individual person. In one embodiment, the average composite score is an arithmetic average of the composite scores of the significant keywords. In one embodiment, the average composite score is an unweighted or weighted root mean square (RMS) of the composite scores of the significant keywords.

Step 360 determines a skill level of the individual person from a comparison of the average composite score with the skill level correlation.

The following example illustrates the process of FIG. 3.

Table 6 depicts an illustrative skill level correlation which correlates skill level with ranges of composite score. The skill level correlation in Table 6 is merely illustrative, and the scope of a correlation of skill level with composite score includes any such correlation including a correlation of skill level expressed as a discrete or continuous function of composite score which may be represented mathematically, graphically, or in a tabular form.

TABLE 6
Skill Level Correlation

| Skill Level | Range of Composite Score |
|---|---|
| 1 | ≥0.90 to ≤1.00 |
| 2 | ≥0.80 to <0.90 |
| 3 | ≥0.70 to <0.80 |
| 4 | ≥0.60 to <0.70 |
| 5 | <0.60 |

In Table 6, the extracted keywords of the individual person from step 330 are denoted as KW1, KW2, KW3, KW4, KW5, KW6, and KW7, of which only 3 extracted keywords (KW1, KW3 and KW5) are in the list of final keywords and are thus 3 significant keywords of the individual person. The 3 significant keywords of KW1, KW3 and KW5 have a composite score of 0.72, 0.65, and 0.88, respectively.

The average composite score, as an arithmetic average, is 0.75 (i.e., (0.72+0.65+0.88)/3), which denotes Skill Level 3 from the skill level correlation shown in Table 6.

FIG. 4 is a flow chart describing use of a first Artificial Intelligence (AI) model, using Natural Language Processing (NLP) techniques, to extract keywords of one or more persons from raw text of the persons, in accordance with embodiments of the present invention. The flow chart of FIG. 4 includes steps 410-460.

In one embodiment, the one or more persons comprise a plurality of persons (e.g., the non-experts and experts of FIG. 1, the first persons and second persons of FIG. 2). In one embodiment, the one or more persons consists of a single person (e.g., the individual persons of FIG. 3).

Step 410 accesses raw text from of the persons. The raw text was received from any source such as, inter alia, telephone conversations, newswire, newsgroups, broadcast news, broadcast conversations, weblogs, user input, etc.

Step 420 cleans the raw text to convert the raw text into a more usable and structured format for subsequent analysis. Cleaning the structured text may be selected from such standard techniques as, inter alia, removing stop words (i.e., common words such as, inter alia, a”, “an”, “and”, “but”, “in”, “on”, “the”, “what”, “will”, which are removed, in one embodiment, by comparison of the raw text with a specified list of stop words), removing or correcting errors, filling in missing values, transforming data types reshaping the data to fit a desired format, case normalization (converting all the words to lowercase or uppercase), punctuation normalization (removing or replacing punctuation marks to improve the readability of the text), lemmatization (reducing words to their base form or lemma to capture the underlying meaning of the word). The preceding standard techniques are well known to a person of ordinary skill in the art.

Step 430 generates tokens from the cleaned raw text by denoting each word as a token (i.e., each token is an individual word of the cleaned raw text).

Step 440 tags each token (i.e., each word) with a Part of Speech (PoS) tag. A PoS tag may be a verb, noun, adjective, direct object, pronoun, adverb, etc.

Step 450 uses a machine learning model (MLM) to generate most relevant keywords from the tagged tokens. Any machine learning model known to a person of ordinary skill in the art as being capable of generating keywords may be used, including inter alia: (i) transformer models (e.g., Bidirectional Encoder Representations from Transformers (BERT), Robustly Optimized BERT Pretraining Approach (ROBERTa), Generative Pre-trained Transformer 3 (GPT-3)); (ii) neural networks (e.g., recurrent neural networks (RNNs), convolutional neural networks (CNNs); (iii) support vector machine (SVM); (iv) Naïve Bayes, etc.

Step 450 is performed using use various parameters that are pertinent to particular machine language model employed in FIG. 4.

Each extracted keyword independently consists of either a single word or two words.

In one embodiment, the MLM selects all of the tokens as single-word keywords.

In one embodiment, the MLM selects a subset of the tokens as single-word keyword based on criteria which may include one or more of: (i) topic relevance: words relevant to a main topic, theme, or subject matter of a document that includes the words; (ii) co-occurrence: words that frequently appear together in a same context or sentence; (iii) position: Words that appear in significant positions such as titles, headings, or beginning of a sentence; (iv) context: words that appear in specific contexts such as technical terms, names, locations, etc.

The MLM selects the two-word keywords via dependency parsing which identifies syntactic dependencies between words in a sentence of the raw text.

In one embodiment, each two-word combination for which a syntactic dependence has been identified by the dependency parsing, and for which each word of the two-word combination is a token, is a two-word keyword.

In one embodiment, each two-word combination for which a syntactic dependence has been identified by the dependency parsing, and for which each word of the two-word combination is a single-word keyword, is a two-word keyword.

Step 460 outputs the most relevant keywords as the keywords extracted by the AI model from the raw text.

FIG. 5 is a flow chart which describes training the first AI model, in accordance with embodiments of the present invention. The flow chart of FIG. 5 includes steps 510-580.

Step 510 accesses raw training text of at least one person. The raw training text was received from any source such as, inter alia, telephone conversations, newswire, newsgroups, broadcast news, broadcast conversations, weblogs, user input, etc.

Steps 520, 530, 540 and 550 are performed in a manner that is similar to, and analogous to, steps 420, 430, 440 and 550 of FIG. 4.

Step 520 cleans the raw training text to convert the raw training text into a more usable and structured format for subsequent analysis.

Step 530 generates tokens from the cleaned raw training text by denoting each word as a token (i.e., each token is an individual word of the cleaned raw training text).

Step 540 tags each token (i.e., each word) with a Part of Speech (PoS) tag. A PoS tag may be a verb, noun, adjective, direct object, pronoun, adverb, etc.

Step 550 uses the same MLM used in step 450 of FIG. 4 to generate most relevant keywords from the tagged tokens in a manner consistent with generation of the most relevant keywords in step 450 of FIG. 4.

Step 550 is performed using use various parameters that are pertinent to particular machine language model employed in FIG. 5. In step 550, the MLM adjusts the parameters to minimize the difference between predicted output and the output data provided in the training data.

Step 560 evaluates the trained MLM resulting from step 550 by repeating steps 510-550 using raw testing text which differs from the raw training text, followed by evaluating the result of step 550 resulting from use of the raw testing text.

The evaluation of step 550 resulting from use of the raw testing text uses metrics including, inter alia, one or more of the following metrics: precision, recall, F1 score, and accuracy.

Precision measures the proportion of correctly identified keywords among all the predicted keywords, which is indicative of the ability of the MLM to avoid false positives. Precision is calculated as true positives divided by the sum of true positives and false positives.

Recall measures the proportion of correctly identified keywords among all the actual keywords, which is indicative of the ability of the MLM to avoid false negatives. Recall is calculated as true positives divided by the sum of true positives and false negatives.

The F1 score is the harmonic mean of precision and recall, which is calculated as 2 times the product of precision and recall, divided by the sum of precision and recall.

Accuracy measures the overall correctness of the model's predictions. Accuracy is calculated as the number of correct predictions divided by the total number of predictions.

Step 570 determines whether the AI model needs to be improved, by assessing whether all of the metrics used in step 560 satisfy specified thresholds.

If step 570 determines that the AI model does not need to be improved (i.e., all of the metrics used in step 560 satisfy the specified thresholds), then the training of the first AI ends.

If step 570 determines that the AI model needs to be improved (i.e., not all of the metrics used in step 560 satisfy the specified thresholds), then step 580 is next performed

Step 580 improves the training of the AI model by either: (i) modifying one of more parameters of the MLM, following by looping back to step 550 to repeat training the MLM; or (ii) modifying the raw testing data (e.g., by changing the previously used raw testing data and/or adding additional raw testing data), following by looping back to step 510 to repeat the AI training process with the changed raw testing data

FIG. 6 is a flow chart describing use of a second Artificial Intelligence (AI) model to determine a similarity of extracted keywords, in accordance with embodiments of the present invention. The flow chart of FIG. 6 includes steps 610-670.

Step 610 accesses the extracted keywords, wherein each extracted keyword consists of a single-word keyword or a two-word keyword.

Step 620 sets the similarity of the single-word keywords to zero.

Steps 630-660 are in a loop over the two-word keywords for calculating a cosine similarity for each two-word keyword. Each iteration of the loop processes one of the two-word keywords.

Step 630 uses a machine learning model to generate a vector of constant length for each word of the two-word keyword, using a known word embedding model such as, inter alia, Word2Vec which is trained to use a shallow neural network (SNN) to learn the meaning of words from a large corpus of texts. The SNN includes an input layer, a hidden layer, and an output layer.

After being trained to generate learned word vectors generated within the hidden layer of the SNN, Word2Vec uses the learned word vectors to generate a vector of numbers representing a current word, where the vector captures the meaning, semantic similarity, and relationship of the current word with text appearing before and after the current word. In one embodiment, each element of the vector representing the current word is 0 or 1.

Step 640 normalizes the vector of each word of the two-word keyword to have a length (i.e., magnitude) between 0 and 1.

Step 650 calculates the similarity as a cosine similarity between the two vectors, A and B, respectively representing the words of the two-word keyword as follows. The cosine similarity of vectors A and B is the scalar product (also known as dot product) of A and B, divided by the product of the magnitude of A and the magnitude of B.

Step 660 determines whether there is at least one more two-word keyword to process.

If step 660 determines that there is at least one more two-word keyword to process then the next iteration of the loop is executed beginning at step 630; otherwise, step 670 is next executed.

Step 670 outputs the similarity of each of the extracted keywords.

FIG. 7 is a flow which describes training the second AI model, in accordance with embodiments of the present invention. The flow chart of FIG. 7 includes steps 710-770.

In particular, the flow chart of FIG. 7 describes training the exemplary machine learning model of Word2Vec whose usage, via a shallow neural network (SNN), has been described supra in conjunction with FIG. 6.

Step 710 determines target words from a corpus of training text, which includes cleaning the training text and tokenizes the cleaned training text into the target words.

Step 720 pairs each target word with context words positioned on each side of the target word, using a sliding window whose size determines the number of context words on each side of the target word.

Step 730 feeds each target-context word pair into the SNN.

Step 740 updates SNN weights to minimize a loss function which measures the discrepancy between predicted probabilities and the actual context words.

Step 750 backpropagates an error signal through the SNN. The error signal is a measure of discrepancy between predicted probabilities and the true context words. The word vectors in the hidden layer are adjusted based on the error signal to improve the SNN.

Step 760 determines whether to perform another iteration through steps 730-760 to improve the accuracy of the word vectors in the hidden layer of the SNN.

If step 760 determines that another iteration should be performed then the next iteration though steps 730-760 is performed; otherwise, step 770 is next executed.

Step 770 outputs the word vectors in the hidden layer of the SNN.

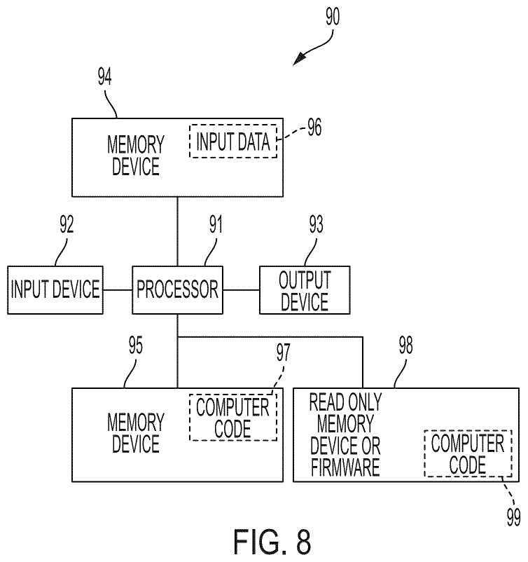

FIG. 8 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 8 shows the computer system 90 as a particular configuration of hardware and software, any configuration of hardware and software, as would be known to a person of ordinary skill in the art, may be utilized for the purposes stated supra in conjunction with the particular computer system 90 of FIG. 8. For example, the memory devices 94 and 95 may be portions of a single memory device rather than separate memory devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

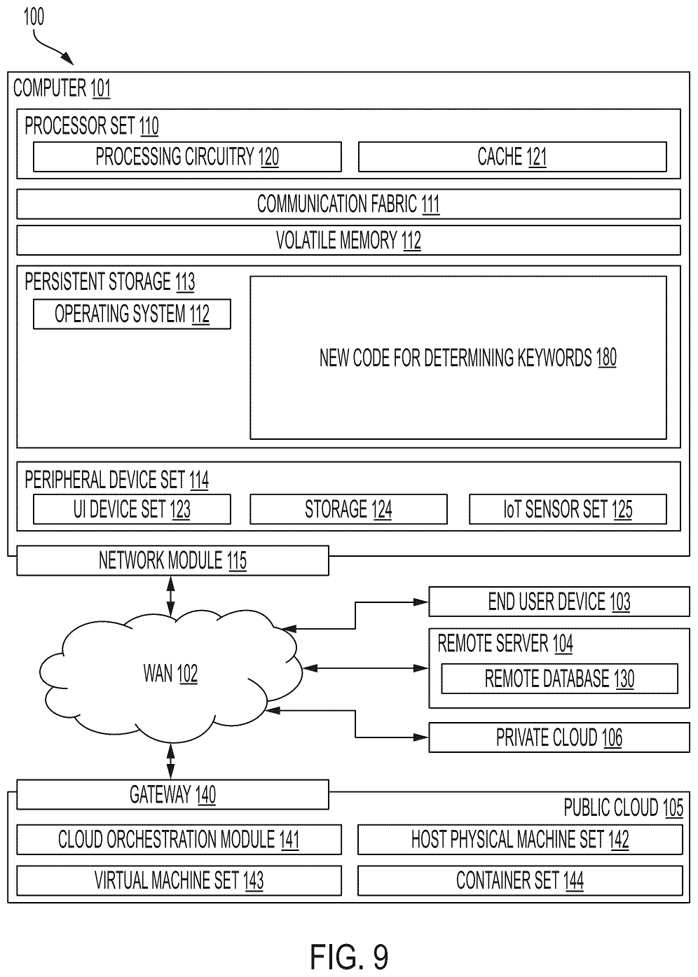

FIG. 9 depicts a computing environment 100 which contains an example of an environment for the execution of at least some of the computer code involved in performing the inventive methods, in accordance with embodiments of the present invention. Such computer code includes new code for determining keywords 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 9. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for determining keywords from raw data, said method comprising:
receiving, by one or more processors of a computer system, a first list of first persons and a second list of second persons, said second persons having been classified as having a higher skill level than the first persons with respect to specified skill level criteria of a specified skill;
using, by the one or more processors, a first trained artificial intelligence model to extract, from text associated with the first persons and the second persons, a first plurality of keywords and a second plurality of keywords for each first person and each second person, respectively, each extracted keyword independently consisting of either a single word or two words;
using, by the one or more processors, a second trained artificial intelligence model to determine a similarity score for each keyword of the first plurality of keywords and for each keyword of the second plurality of keywords, said similarity score being zero for each keyword consisting of a single word and being a numerical measure of similarity between the two words in each keyword consisting of two words;
determining, by the one or more processors, a keyword frequency rank, a mean similarity rank, and a person frequency rank for each keyword of the first plurality of keywords and for each keyword of the second plurality of keywords;
computing a composite score as a function of the keyword frequency rank, the similarity rank, and the person frequency rank for each keyword of the first plurality of keywords and for each keyword of the second plurality of keywords; and
generating, by the one or more processors, a final list of keywords consisting of keywords in the second plurality of keywords based on the composite score of all of the keywords in both the first plurality of keywords and the second plurality of keywords.

2. The method of claim 1, wherein said generating the final list of keywords comprises:
generating, by the one or more processors, a third and fourth plurality of keywords comprising only those keywords in the first plurality of keywords and in the second plurality of keywords, respectively, whose composite score is equal to or greater than a specified composite score threshold that is a positive real number; and
creating the final list of keywords consisting of keywords in the fourth plurality of keywords based on a comparison of the keywords in the fourth plurality of keywords with keywords in the third plurality of keywords.

3. The method of claim 2, wherein the final list of keywords resulting from said comparison consists of (i) all keywords in the fourth plurality of keywords not existing in the third plurality of keywords and (ii) all keywords in the fourth plurality of keywords whose composite score exceeds the composite score of the same keywords in the third plurality of keywords.

4. The method of claim 3, said method further comprising determining, by the one or more processors, a skill level of an individual person by:
receiving a skill level correlation which corelates skill level with ranges of composite score;
receiving raw text of the individual person;
using the first AI model to extract keywords of the individual person from the raw text of the individual person;
generating a list of significant keywords of the individual person by removing all extracted keywords of the individual person that do not match any keyword on the list of final keywords;
computing an average composite score averaged over the significant keywords of the individual person; and
determining the skill level of the individual person from a comparison of the average composite core with the skill level correlation.

5. The method of claim 1, said method further comprising:
before said using the first trained artificial intelligence model, training the first trained artificial intelligence model.

6. The method of claim 1, said method further comprising:
before said using the second trained artificial intelligence model, training the second trained artificial intelligence model.

7. The method of claim 1, wherein the keyword frequency rank, the similarity rank, and the person frequency rank for each keyword are denoted as KFR, SR, and PFR, respectively, and wherein the composite score (CS) is computed as CS=w1*(KFR)ⁿ¹+w2*(SR)ⁿ²+w3*(PFR)ⁿ³, wherein w1, w2, w3, n1, n2, and n3 are positive real numbers.

8. The method of claim 7, wherein at least one of w1, w2 and w3 for each keyword has a numerical value in dependence on a Part of Speech (PoS), or a PoS combination, of said each keyword.

9. A computer program product, comprising one or more computer readable hardware storage devices having computer readable program code stored therein, said program code containing instructions executable by one or more processors of a computer system to implement a method for determining keywords from raw data, said method comprising:
receiving, by the one or more processors, a first list of first persons and a second list of second persons, said second persons having been classified as having a higher skill level than the first persons with respect to specified skill level criteria of a specified skill;
using, by the one or more processors, a first trained artificial intelligence model to extract, from text associated with the first persons and the second persons, a first plurality of keywords and a second plurality of keywords for each first person and each second person, respectively, each extracted keyword independently consisting of either a single word or two words;
using, by the one or more processors, a second trained artificial intelligence model to determine a similarity score for each keyword of the first plurality of keywords and for each keyword of the second plurality of keywords, said similarity score being zero for each keyword consisting of a single word and being a numerical measure of similarity between the two words in each keyword consisting of two words;
determining, by the one or more processors, a keyword frequency rank, a mean similarity rank, and a person frequency rank for each keyword of the first plurality of keywords and for each keyword of the second plurality of keywords;
computing a composite score as a function of the keyword frequency rank, the similarity rank, and the person frequency rank for each keyword of the first plurality of keywords and for each keyword of the second plurality of keywords; and
generating, by the one or more processors, a final list of keywords consisting of keywords in the second plurality of keywords based on the composite score of all of the keywords in both the first plurality of keywords and the second plurality of keywords.

10. The computer program product of claim 9, wherein said generating the final list of keywords comprises:
generating, by the one or more processors, a third and fourth plurality of keywords comprising only those keywords in the first plurality of keywords and in the second plurality of keywords, respectively, whose composite score is equal to or greater than a specified composite score threshold that is a positive real number; and
creating the final list of keywords consisting of keywords in the fourth plurality of keywords based on a comparison of the keywords in the fourth plurality of keywords with keywords in the third plurality of keywords.

11. The computer program product of claim 10, wherein the final list of keywords resulting from said comparison consists of (i) all keywords in the fourth plurality of keywords not existing in the third plurality of keywords and (ii) all keywords in the fourth plurality of keywords whose composite score exceeds the composite score of the same keywords in the third plurality of keywords.

12. The computer program product of claim 11, said method further comprising determining, by the one or more processors, a skill level of an individual person by:
receiving a skill level correlation which corelates skill level with ranges of composite score;
receiving raw text of the individual person;
using the first AI model to extract keywords of the individual person from the raw text of the individual person;
generating a list of significant keywords of the individual person by removing all extracted keywords of the individual person that do not match any keyword on the list of final keywords;
computing an average composite score averaged over the significant keywords of the individual person; and
determining the skill level of the individual person from a comparison of the average composite core with the skill level correlation.

13. The computer program product of claim 9, said method further comprising:
before said using the first trained artificial intelligence model, training the first trained artificial intelligence model.

14. The computer program product of claim 9, said method further comprising:
before said using the second trained artificial intelligence model, training the second trained artificial intelligence model.

15. The computer program product of claim 9, wherein the keyword frequency rank, the similarity rank, and the person frequency rank for each password are denoted as KFR, SR, and PFR, respectively, and wherein the composite score (CS) is computed as CS=[((KFR)ⁿ+(SR)ⁿ+(PFR)ⁿ)/3]^{1/n}, wherein n is a positive real number.

16. A computer system, comprising one or more processors, one or more memories, and one or more computer readable hardware storage devices, said one or more hardware storage devices containing program code executable by the one or more processors via the one or more memories to implement a method for determining keywords from raw data, said method comprising:
receiving, by the one or more processors, a first list of first persons and a second list of second persons, said second persons having been classified as having a higher skill level than the first persons with respect to specified skill level criteria of a specified skill;
using, by the one or more processors, a first trained artificial intelligence model to extract, from text associated with the first persons and the second persons, a first plurality of keywords and a second plurality of keywords for each first person and each second person, respectively, each extracted keyword independently consisting of either a single word or two words;
using, by the one or more processors, a second trained artificial intelligence model to determine a similarity score for each keyword of the first plurality of keywords and for each keyword of the second plurality of keywords, said similarity score being zero for each keyword consisting of a single word and being a numerical measure of similarity between the two words in each keyword consisting of two words;
determining, by the one or more processors, a keyword frequency rank, a mean similarity rank, and a person frequency rank for each keyword of the first plurality of keywords and for each keyword of the second plurality of keywords;
computing a composite score as a function of the keyword frequency rank, the similarity rank, and the person frequency rank for each keyword of the first plurality of keywords and for each keyword of the second plurality of keywords;
generating, by the one or more processors, a third and fourth plurality of keywords comprising only those keywords in the first plurality of keywords and in the second plurality of keywords, respectively, whose composite score is equal to or greater than a specified composite score threshold that is a positive real number; and
generating, by the one or more processors, a final list of keywords consisting of (i) all keywords in the fourth plurality of keywords not existing in the third plurality of keywords and (ii) all keywords in the fourth plurality of keywords whose composite score exceeds the composite score of the same keywords in the third plurality of keywords.

17. The computer system of claim 16, said method further comprising determining, by the one or more processors, a skill level of an individual person by:
receiving a skill level correlation which corelates skill level with ranges of composite score;
receiving raw text of the individual person;
using the first AI model to extract keywords of the individual person from the raw text of the individual person;
generating a list of significant keywords of the individual person by removing all extracted keywords of the individual person that do not match any keyword on the list of final keywords;
computing an average composite score averaged over the significant keywords of the individual person; and
determining the skill level of the individual person from a comparison of the average composite core with the skill level correlation.

18. The computer system of claim 16, said method further comprising:
before said using the first trained artificial intelligence model, training the first trained artificial intelligence model.

19. The computer system of claim 16, said method further comprising:
before said using the second trained artificial intelligence model, training the second trained artificial intelligence model.

20. The computer system of claim 16, wherein the keyword frequency rank, the similarity rank, and the person frequency rank for each password are denoted as KFR, SR, and PFR, respectively, and wherein the composite score (CS) is computed as CS=KFR*SR*PFR if SR>0 and CS=KFR*PFR if SR=0.
